(19) United States
(12) Patent Application Publication
(10) Pub. No.: US 2016/0232586 A1
(43) Pub. Date: Aug. 11, 2016

(54) SYSTEM AND METHOD FOR SHARING GEOPRAPHICAL VIEWS WITH REMOTE USERS THROUGH AN ONLINE MARKETPLACE

(71) Applicants: David Kean Peyman, Richmond, VA (US); Nazmi Peyman, Richmond, VA (US)

(72) Inventors: David Kean Peyman, Richmond, VA (US); Nazmi Peyman, Richmond, VA (US)

(21) Appl. No.: 15/131,629

(22) Filed: Apr. 18, 2016

(51) Int. Cl. G06Q 30/06; H04N 5/225

(52) U.S. Cl. CPC G06Q 30/0601; H04N 5/225

(57) ABSTRACT

The embodiments herein provide a system and method for capturing and sharing a geographical view with several users through an online marketplace. The system is provided for capturing, sharing and monetizing a view of a geographical location. The system comprises the view capturing devices, a digital storage mechanism, an online marketplace and the buyers. The audio and video data of a geographical view acquired with the view capturing devices are stored on a digital storage mechanism. An online marketplace is provided to share the captured geographical views on sale/rent/lease with the buyers. Upon a successful purchase, the captured views are rendered on suitable display devices.

### BACKGROUND

1. Technical Field

The embodiments herein are generally related to an online marketplace. The embodiments herein are particularly related to a system and a method for capturing geographical views from multiple locations and sharing the captured view through an online marketplace. The embodiments herein are more particularly related to a system and a method for projecting a desired geographical view on a window of building to mimic a desired location by acquiring the desired geographical view through an online marketplace.

2. Description of the Related Art

The geographical location of a person determines the kind of view a person has outside their living place or workplace. Virtual simulation of a plurality of geographical views enables a person to feel as if the person is actually present in the desired geographical location with the desired simulated view. With an advancement of today's technology in high speed interne, high definition TVs, sound recording and broadcasting systems and cameras, it is possible to record and broadcast a geographical view from a popular location to any remote part of the world.

The presently available systems does not match the users willingness to rent/lease/sell the acquired view/scene from ones windows at a place of residence or vacation or business to one or multiple users at remote or closer locations across the world to provide a real time virtual/actual view in real time or in a time adjusted mode.

A system is required to transmit a real-time recorded view to the desired users to enable the users to experience or mimic a living of a desired geographical location at a window of one's own residence or building or office by projecting a real time view of a desired geographical location in real time or in time adjusted mode on an affordable cost through a common online market place/platform/portal.

Hence, there is a need for developing a system and method for capturing a window side view/scene of a desired geographical locations/areas/spots and sharing the captured window side view with a plurality of users at a cost through an online market place or portal. Further there is a need for a system and method for capturing a window side view/scene of a desired geographical locations/areas/spots and transmitting a real-time recorded view to the desired users to enable the users to experience or mimic a living of a desired geographical location at a window of one's own residence or building or office by projecting a real time view of a desired geographical location in real time or in time adjusted mode on an affordable cost through a common online market place. Still further there is a need for a system and method for projecting a desired window side view of a desired geographical location on a window of one's own residence or building or office with audio in real time or time adjusted mode to mimic or experience a living of a desired geographical location even without living in the desired geographical location actually and in reality. Yet there is a need for a system and method for developing a platform or creating a website/portal for matching the users' willingness to rent/lease/sell the captured view from the windows at a place of residence or vacation or business to one or more users at remote or closer locations across the world/globe. Yet there is a need for a system and method for developing a platform or creating a website/portal for sharing the captured view from the windows at a place of residence or vacation or business to one or more users at remote or closer locations across the world/globe and thereby earning an income by way of collecting a percentage or fixed rate or membership fees, etc., from the buyers, renters, leases or sellers. Yet there is a need for a system and method to monetize the sharing of geographical views and render the captured geographical views on a user's display devices.

The abovementioned shortcomings, disadvantages and problems are addressed herein and which will be understood by reading and studying the following specification.

### OBJECT OF THE EMBODIMENTS HEREIN

The primary object of the embodiments herein is to provide a system and a method for capturing a window side view/scene of a desired geographical locations/areas/spots and sharing the captured window side view with a plurality of users at a cost through an online market place.

Another object of the embodiments herein is to provide a system and a method for capturing a window side view/scene of a desired geographical locations/areas/spots and transmitting a real-time recorded view to the desired users to enable the users to experience or mimic a living of a desired geographical location at a window of one's own residence or building or office by projecting a real time view of a desired geographical location in live or real time or in time adjusted mode on an affordable cost through a common online market place.

Yet another object of the embodiments herein is to provide a system and a method for projecting a desired window side view of a desired geographical location on a window of one's own residence or building or office with audio in real time or time adjusted mode to mimic or experience a living of a desired geographical location even without living in the desired geographical location actually and in reality.

Yet another object of the embodiments herein is to provide a system and a method for developing a platform or creating a website/portal for matching the users willingness to rent/lease/sell the captured view from the windows at a place of residence or vacation or business to one or more users at remote or closer locations across the world/globe.

Yet another object of the embodiments herein is to provide a system and a method for developing a platform or creating a website/portal for sharing the captured view from the windows at a place of residence or vacation or business to one or more users at remote or closer locations across the world/globe and thereby earning an income by way of collecting a percentage or fixed rate or membership fees, etc., from the buyers, renters, leases or sellers.

Yet another object of the embodiments herein is to provide a system and a method to monetize the sharing of geographical views and render the captured geographical views on a user's display devices.

Yet another object of the embodiments herein is to provide a system and a method to develop a platform or website to allow the people to share their view from their homes or business with others who are located far away from that view and don't have the access to the view by allowing the owner to pay accordingly.

Yet another object of the embodiments herein is to provide a system and a method to capture a window side view and/or sound through a plurality of different video and sound recording technologies, such as regular or HD or 3D or hologram, etc.

Yet another object of the embodiments herein is to provide a system and a method to transmit or broadcast a captured a window side view and/or sound through the wireless or wired internet connections to the receiver live or time adjusted mode in regular, 3D or hologram, formats with regular or HD sound format.

Yet another object of the embodiments herein is to provide a system and a method to enable a broadcaster (person who has access to the view) to charge a price for sharing the view.

Yet another object of the embodiments herein is to provide a system and a method to generate a portal/website to share and sell the captured videos and audios to required or desired users to earn a percentage of the revenues or a fixed amount depending on the prior agreement.

Yet another object of the embodiments herein is to provide a system and method to broadcast the captured and uploaded videos and audios to a receiver device for projecting/displaying on a screen that looks like an ordinary window to simulate an actual presence on that location in live or time adjusted based on time zone difference at a remote location.

Yet another object of the embodiments herein is to provide a system and method to project the desired geographical view on a residential or commercial place of a user thereby enabling the user to view/see the desired place of living in real time or time adjusted mode by opening a blind.

Yet another object of the embodiments herein is to provide a system and a method to broadcast the desired geographical view on a mobile or a desk-top computer screen, Television set or a screen that is designed to mimic and/or is built like a window in a residential, hotel or commercial space with the possibility of adding sound, thereby simulating a condition of living or working in the more popular and hard to access locations or visiting the location without paying the higher expenses of living or travel expenses.

Yet another object of the embodiments herein is to provide a system and a method to enable the users to place the projectors and cameras alternatively in a popular locations with no actual windows to broadcast the videos/pictures with and without sound thereby enabling a reconstruction of a desired scenario/scene at the remote location as one or more small or large windows.

Yet another object of the embodiments herein is to provide a system and a method to provide a portal/platform/website to provide an online market place for the buyers and sellers/renters to find one or more matches for a fixed rate or auction by paying a percentage or a fixed rate or a membership fee to the portal/platform/website.

Yet another object of the embodiments herein is to provide a system and a method to stream the picture/video and/or sound through the window in a real-time manner with or without sound or be pre-recorded and/or adjusted for the time zone difference between the locations.

Yet another object of the embodiments herein is to provide a system and a method to provide a website/portal/platform for matching the owners of the sought after “window views” with a potential short or long term renters/leasers or buyers (one or more), through an auction system or a fixed onetime payment or subscription or repetitive periodic payments.

Yet another object of the embodiments herein is to provide a system and a method to provide more realistic geographical views on windows of buildings using 3D windows, high and higher definition video and sound systems.

Yet another object of the embodiments herein is to provide a system and a method for capturing a geographical view and sharing the captured view with a plurality of users through an online marketplace.

Yet another object of the embodiments herein is to provide a system and a method for capturing a real-time or live or deferred audio-visual data of a geographical view.

Yet another object of the embodiments herein is to provide an online marketplace where geographical views are shared and monetized.

Yet another object of the embodiments herein is to provide a method to monetize the sharing of geographical view through a subscription model or purchase, rent, or lease.

Yet another object of the embodiments herein is to provide a method and a system to enable a rendering of a captured view from one remote geographical location to another remote geographical location, where the end-user is present.

Yet another object of the embodiments herein is to provide a system and a method to enable the end-user with an option to choose from a plurality of geographical locations to be rendered.

Yet another object of the embodiments herein is to provide a system and a method to record or broadcast a live view from a window facing a popular view, say view of the Niagara falls or New York's Times Square, etc., with today's technology of high speed internet, high definition TVs, sound recording and broadcasting systems and cameras and share the captured view with people in close or remote locations across the globe/world.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and a method for capturing a geographical view of a desired location and sharing the captured view with a plurality of users through an online marketplace.

According an embodiment herein, a system is provided for capturing, storing, sharing and monetizing a window view/scene from a geographical location. The system comprises a plurality of view capturing devices located at a plurality of geographical locations. The plurality of view capturing devices includes a plurality of image capturing devices and/or a plurality of audio capturing devices. The plurality of image capturing devices is configured to capture and record a video, or a still picture image of a desired scene/window side view of a desired geographical location. The plurality of audio capturing devices is configured to capture and record an audio of a desired scene/window side view of a desired geographical location.

A digital storage mechanism or a data base is configured to store the captured video, images and audio in a digital format. The storage mechanism is located locally or remotely to the view capturing devices. The captured video, images and audio are transferred from the view capturing devices to the storage mechanism through a wired/wireless network.

A server is provided on a portal//platform. The server is connected to the plurality of view capturing devices and the digital storage medium to receive and store the captured images and audios of the plurality of geographical locations. The server is configured to share the captured images and audios of the plurality of geographical locations with a plurality of users. The plurality of users includes a plurality of buyers, sellers, lessees.

According an embodiment herein, the plurality of buyers are enabled to acquire the captured images and audios of the plurality of geographical locations for projecting the captured images and audios on a window in a building of the buyers to simulate a live or recorded view of a desired geographical location. The captured images and audios are broadcast in a real time or live or in a time adjusted mode based on a time difference and time zone difference between the geographical location and a projected location.

According an embodiment herein, the captured images are projected in a two dimension format or three dimensional format.

According an embodiment herein, the captured audios are output in mono mode or stereo mode.

According an embodiment herein, the captured views are shared in real-time or live or in deferred mode based on a plurality of preferences. The plurality of preferences includes a time of day, season or type of geographical phenomenon. The preferences are set by the user who buys or rents or leases the captured images and audios.

According an embodiment herein, the system further comprises a simulation engine/system to simulate a live atmosphere or environment of a desired geographical location based on the captured images and/or audios of the desired application on a window of the building.

According an embodiment herein, the building is any one of a residential building, a commercial building and an office building.

According an embodiment herein, the window of the building is a Three Dimensional Window screen.

According an embodiment herein, the system further comprises projectors or televisions to display the captured audio and/or video of the desired geographical location. The television is a normal or a high-definition television receiver set.

According an embodiment herein, the image capturing device is a camera or a video camera.

According an embodiment herein, the data transmission system is a broadcast system.

According an embodiment herein, the plurality of view capturing devices is mounted on a viewing window.

According an embodiment herein, the captured video is transmitted as a video stream and wherein the captured audio is transmitted as an audio stream.

According an embodiment herein, the data base is a cloud database.

According an embodiment herein, a computer implemented method comprising instructions stored on a non-transitory computer readable storage medium and run on a computing device provided with a hardware processor and memory for capturing, sharing and projecting a window side view of a desired geographical location on a window of a user building is provided. The method comprises the steps of capturing a window side view of a plurality of geographical locations with a plurality of view capturing devices. The plurality of view capturing devices is located at a plurality of geographical locations. The plurality of view capturing devices includes a plurality of image capturing devices and/or a plurality of audio capturing devices. The plurality of image capturing devices is configured to capture and record a video, or a still picture image of a desired scene/window side view of a desired geographical location. The plurality of audio capturing devices is configured to capture and record an audio of a desired scene/window side view of a desired geographical location. The plurality of view capturing devices is mounted on a viewing window. The image capturing device is a camera or a video camera.

The captured video/image and/or audio of the plurality of geographical locations are stored in a storage database. The storage database is a cloud database.

The captured video/image and/or audio of the plurality of geographical locations are listed on a portal/platform through a server. The server is provided on a portal//platform. The server is connected to the plurality of view capturing devices and the digital storage medium to receive and store the captured images and/or audios of the plurality of geographical locations. The server is configured to share the captured images and/or audios of the plurality of geographical locations with a plurality of users after enrolling the plurality of users. The plurality of users includes a plurality of buyers, sellers, lessees. The portal is configured to enable the plurality of users to purchase or rent or lease the plurality of captured video/image and/or audio in an online marketplace.

A view of a desired geographical location is identifying from the list of the captured video/image and/or audio of the plurality of geographical locations on a portal/platform through the user computing device and the server.

A payment is made to receive the identified view of the desired geographical location through the portal. The payment is made to buy or subscribe or to receive on lease the receive the identified view of the desired geographical location;

The identified view of the desired geographical location is transmitted or transferred to the user device from the portal after confirming the receipt of payment from the user.

The identified view of the desired geographical location is rendered on a display screen provided on the window to mimic or simulate or to project a window side view of the desired geographical location in real time or in live mode or in a time adjusted mode based on the a time difference between the time zones of captured and displayed geographical locations.

According an embodiment herein, the captured images are projected in a two dimension format or three dimensional format. The captured audios are output in mono mode or stereo mode. The captured video is transmitted as a video stream. The captured audio is transmitted as an audio stream.

According an embodiment herein, the captured views are shared in real-time or live or in deferred mode based on a plurality of preferences. The plurality of preferences includes a time of day, season or type of geographical phenomenon. The preferences are set by the user who buys or rents or leases the captured images and audios.

According an embodiment herein, the method 4, further comprises simulating a live atmosphere or environment of a desired geographical location based on the captured images and/or audios of the desired application on a window of the building using a simulation engine.

According an embodiment herein, the building is any one of a residential building, a commercial building and an office building. The window of the building is a Three Dimensional Window screen.

According an embodiment herein, the method further comprises displaying the captured audio and/or video of the desired geographical location through projectors or televisions. The television is a normal or a high-definition television receiver set.

According an embodiment herein, the method further comprises transmitting the captured video and/or audio of the plurality of geographical locations through a broadcast system.

According to an embodiment herein, a system for capturing, storing, sharing and monetizing a view from a geographical location is provided. The system comprises a plurality of view capturing devices, a digital storage mechanism, an online marketplace/portal/server and a plurality of buyers. The plurality of view capturing devices is located at one or more geographical locations or at a desired geographical location. The devices are configured to record audio and video data of a geographical location view. The digital storage mechanism stores the captured views in a digital format. The storage mechanism is located locally or remotely to the view capturing devices. The data transfer is transferred from the view capturing devices to the storage mechanism through a communication medium. The online marketplace is configured to share the geographical views captured through a plurality of view capturing devices in the form of audio and video streams/format. The captured views are monetized by way of sales/rent/leasing of the plurality of captured views to a plurality of buyers. The plurality of buyers are provided to access the captured views through a computing device. The buyers are enabled to purchase a plurality of views through the online marketplace. Upon a successful purchase/renting/leasing of a plurality of captured views, the buyers are enabled to render the plurality of captured views on suitable display devices.

According to an embodiment herein, the plurality of view capturing devices are enabled to capture a view in multi-dimensional mode. The captured view comprises images or audio visual content in two-dimension or audio visual content in three-dimension.

According to an embodiment herein, the online marketplace enables the users to get registered and share the geographical views captured through the users' devices.

According to an embodiment herein, the online marketplace enables the users to purchase or rent or lease a plurality of views by registering on the online marketplace.

According to an embodiment herein, the captured views are shared real-time, or deferred based on factors such as the time of day, season or type of geographical phenomenon. The preferences of the view are determined by the user who buys or rents or leases the views.

According to an embodiment herein, the users are enabled to monetize the captured views through a plurality of buyers who purchase or lease or rent a plurality of views based on a fixed rate or a membership fees or a percentage of the cost of capturing a view.

According to an embodiment herein, a method of sharing a plurality of views with a plurality of users and monetizing is provided. The process comprises the steps of capturing a view information using a plurality of audio and video capture devices; storing the captured view information in a storage database; listing a plurality of views and enabling the purchase or renting or leasing of the plurality of views in an online marketplace by a plurality of buyers. A plurality of users or buyers, identifies a view, pays money by enrolling on the online marketplace and chooses the view for subscription or rent or purchase. The view chosen and subscribed by the buyer is rendered on a plurality of display devices of the user.

According to an embodiment herein, the plurality of views is rendered on a computing device or dedicated display devices.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a system for capturing, monetizing and sharing a geographical view, according to an embodiment herein.

FIG. 2 illustrates a flowchart explaining a process of sharing a plurality of geographical views with a plurality of users and monetizing, according to an embodiment herein.

FIG. 3 illustrates a circuit block diagram of a system for capturing, monetizing and sharing a geographical view, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and a method for capturing a geographical view of a desired location and sharing the captured view with a plurality of users through an online marketplace.

According an embodiment herein, a system is provided for capturing, storing, sharing and monetizing a window view/scene from a geographical location. The system comprises a plurality of view capturing devices located at a plurality of geographical locations. The plurality of view capturing devices includes a plurality of image capturing devices and/or a plurality of audio capturing devices. The plurality of image capturing devices is configured to capture and record a video, or a still picture image of a desired scene/window side view of a desired geographical location. The plurality of audio capturing devices is configured to capture and record an audio of a desired scene/window side view of a desired geographical location.

A digital storage mechanism or a data base is configured to store the captured video, images and audio in a digital format. The storage mechanism is located locally or remotely to the view capturing devices. The captured video, images and audio are transferred from the view capturing devices to the storage mechanism through a wired/wireless network.

A server is provided on a portal//platform. The server is connected to the plurality of view capturing devices and the digital storage medium to receive and store the captured images and audios of the plurality of geographical locations. The server is configured to share the captured images and audios of the plurality of geographical locations with a plurality of users. The plurality of users includes a plurality of buyers, sellers, lessees.

According an embodiment herein, the plurality of buyers are enabled to acquire the captured images and audios of the plurality of geographical locations for projecting the captured images and audios on a window in a building of the buyers to simulate a live or recorded view of a desired geographical location. The captured images and audios are broadcast in a real time or live or in a time adjusted mode based on a time difference and time zone difference between the geographical location and a projected location.

According an embodiment herein, the captured images are projected in a two dimension format or three dimensional format.

According an embodiment herein, the captured audios are output in mono mode or stereo mode.

According an embodiment herein, the captured views are shared in real-time or live or in deferred mode based on a plurality of preferences. The plurality of preferences includes a time of day, season or type of geographical phenomenon. The preferences are set by the user who buys or rents or leases the captured images and audios.

According an embodiment herein, the system further comprises a simulation engine/system to simulate a live atmosphere or environment of a desired geographical location based on the captured images and/or audios of the desired application on a window of the building.

According an embodiment herein, the building is any one of a residential building, a commercial building and an office building.

According an embodiment herein, the window of the building is a Three Dimensional Window screen.

According an embodiment herein, the system further comprises projectors or televisions to display the captured audio and/or video of the desired geographical location. The television is a normal or a high-definition television receiver set.

According an embodiment herein, the image capturing device is a camera or a video camera.

According an embodiment herein, the data transmission system is a broadcast system.

According an embodiment herein, the plurality of view capturing devices is mounted on a viewing window.

According an embodiment herein, the captured video is transmitted as a video stream and wherein the captured audio is transmitted as an audio stream.

According an embodiment herein, the data base is a cloud database.

According an embodiment herein, a computer implemented method comprising instructions stored on a non-transitory computer readable storage medium and run on a computing device provided with a hardware processor and memory for capturing, sharing and projecting a window side view of a desired geographical location on a window of a user building is provided. The method comprises the steps of capturing a window side view of a plurality of geographical locations with a plurality of view capturing devices. The plurality of view capturing devices is located at a plurality of geographical locations. The plurality of view capturing devices includes a plurality of image capturing devices and/or a plurality of audio capturing devices. The plurality of image capturing devices is configured to capture and record a video, or a still picture image of a desired scene/window side view of a desired geographical location. The plurality of audio capturing devices is configured to capture and record an audio of a desired scene/window side view of a desired geographical location. The plurality of view capturing devices is mounted on a viewing window. The image capturing device is a camera or a video camera.

The captured video/image and/or audio of the plurality of geographical locations are stored in a storage database. The storage database is a cloud database.

The captured video/image and/or audio of the plurality of geographical locations are listed on a portal/platform through a server. The server is provided on a portal//platform. The server is connected to the plurality of view capturing devices and the digital storage medium to receive and store the captured images and/or audios of the plurality of geographical locations. The server is configured to share the captured images and/or audios of the plurality of geographical locations with a plurality of users after enrolling the plurality of users. The plurality of users includes a plurality of buyers, sellers, lessees. The portal is configured to enable the plurality of users to purchase or rent or lease the plurality of captured video/image and/or audio in an online marketplace.

A view of a desired geographical location is identifying from the list of the captured video/image and/or audio of the plurality of geographical locations on a portal/platform through the user computing device and the server.

A payment is made to receive the identified view of the desired geographical location through the portal. The payment is made to buy or subscribe or to receive on lease the receive the identified view of the desired geographical location;

The identified view of the desired geographical location is transmitted or transferred to the user device from the portal after confirming the receipt of payment from the user.

The identified view of the desired geographical location is rendered on a display screen provided on the window to mimic or simulate or to project a window side view of the desired geographical location in real time or in live mode or in a time adjusted mode based on the a time difference between the time zones of captured and displayed geographical locations.

According an embodiment herein, the captured images are projected in a two dimension format or three dimensional format. The captured audios are output in mono mode or stereo mode. The captured video is transmitted as a video stream. The captured audio is transmitted as an audio stream.

According an embodiment herein, the captured views are shared in real-time or live or in deferred mode based on a plurality of preferences. The plurality of preferences includes a time of day, season or type of geographical phenomenon. The preferences are set by the user who buys or rents or leases the captured images and audios.

According an embodiment herein, the method 4, further comprises simulating a live atmosphere or environment of a desired geographical location based on the captured images and/or audios of the desired application on a window of the building using a simulation engine.

According an embodiment herein, the building is any one of a residential building, a commercial building and an office building. The window of the building is a Three Dimensional Window screen.

According an embodiment herein, the method further comprises displaying the captured audio and/or video of the desired geographical location through projectors or televisions. The television is a normal or a high-definition television receiver set.

According an embodiment herein, the method further comprises transmitting the captured video and/or audio of the plurality of geographical locations through a broadcast system.

According to an embodiment herein, a system for capturing, storing, sharing and monetizing a view from a geographical location is provided. The system comprises a plurality of view capturing devices, a digital storage mechanism, an online marketplace/portal/server and a plurality of buyers. The plurality of view capturing devices is located at one or more geographical locations or at a desired geographical location. The devices are configured to record audio and video data of a geographical location view. The digital storage mechanism stores the captured views in a digital format. The storage mechanism is located locally or remotely to the view capturing devices. The data transfer is transferred from the view capturing devices to the storage mechanism through a communication medium. The online marketplace is configured to share the geographical views captured through a plurality of view capturing devices in the form of audio and video streams/format. The captured views are monetized by way of sales/rent/leasing of the plurality of captured views to a plurality of buyers. The plurality of buyers are provided to access the captured views through a computing device. The buyers are enabled to purchase a plurality of views through the online marketplace. Upon a successful purchase/renting/leasing of a plurality of captured views, the buyers are enabled to render the plurality of captured views on suitable display devices.

According to an embodiment herein, the plurality of view capturing devices are enabled to capture a view in multi-dimensional mode. The captured view comprises images or audio visual content in two-dimension or audio visual content in three-dimension.

According to an embodiment herein, the online marketplace enables the users to get registered and share the geographical views captured through the users' devices.

According to an embodiment herein, the online marketplace enables the users to purchase or rent or lease a plurality of views by registering on the online marketplace.

According to an embodiment herein, the captured views are shared in real-time, or live or deferred based on factors such as the time of day, season or type of geographical phenomenon. The preferences of the view are determined by the user who buys or rents or leases the views.

According to an embodiment herein, the users are enabled to monetize the captured views through a plurality of buyers who purchase or lease or rent a plurality of views based on a fixed rate or a membership fees or a percentage of the cost of capturing a view.

According to an embodiment herein, a method of sharing a plurality of views with a plurality of users and monetizing is provided. The process comprises the steps of capturing a view information using a plurality of audio and video capture devices; storing the captured view information in a storage database; listing a plurality of views and enabling the purchase or renting or leasing of the plurality of views in an online marketplace by a plurality of buyers. A plurality of users or buyers, is enabled to identify a view, pay money by enrolling on the online marketplace and choose the view for subscription or rent or purchase. The view chosen and subscribed by the buyer is rendered on a plurality of display devices of the user.

According to an embodiment herein, the plurality of views is rendered on a computing device or dedicated display devices.

According to an embodiment herein, a system and a method are provided for capturing a window side view/scene of a desired geographical locations/areas/spots and sharing the captured window side view with a plurality of users at a cost through an online market place.

According to an embodiment herein, a system and a method are provided for capturing a window side view/scene of a desired geographical locations/areas/spots and transmitting a real-time recorded view to the desired users to enable the users to experience or mimic a living of a desired geographical location at a window of one's own residence or building or office by projecting a real time view of a desired geographical location in real time or in time adjusted mode on an affordable cost through a common online market place.

According to an embodiment herein, a system and a method are provided for projecting a desired window side view of a desired geographical location on a window of one's own residence or building or office with audio in real time or live or time adjusted mode to mimic or experience a living of a desired geographical location even without living in the desired geographical location actually and in reality.

According to an embodiment herein, a system and a method are provided for developing a platform or creating a website/portal for matching the users willingness to rent/lease/sell the captured view from the windows at a place of residence or vacation or business to one or multiple users at remote or closer locations across the world/globe.

According to an embodiment herein, a system and a method are provided for developing a platform or creating a website/portal for sharing the captured view from the windows at a place of residence or vacation or business to one or multiple users at remote or closer locations across the world/globe and thereby earning an income by way of collecting a percentage or fixed rate or membership fees, etc., from the buyers, renters, leases or sellers.

According to an embodiment herein, a system and a method are provided to monetize the sharing of geographical views and render the captured geographical views on a user's display devices.

According to an embodiment herein, a system and a method are provided to develop a platform or website to allow the people to share their views from their homes or business with others who are located far away from that view and don't have an access to the view by allowing the owner to pay accordingly.

According to an embodiment herein, a system and a method are provided to capture a window side view and sound through a plurality of different video and sound recording technologies, such as regular or HD or 3D or hologram, etc.

According to an embodiment herein, a system and a method are provided to transmit or broadcast the captured window side view and sound through the wireless or wired internet connections to the receiver live or time adjusted mode in regular, 3D or hologram, formats with regular or HD sound format.

According to an embodiment herein, a system and a method are provided to enable a broadcaster (person who has access to the view) to charge a price for sharing the view.

According to an embodiment herein, a system and a method are provided to generate a portal/website to share and sell the captured videos and audios to the required or desired users to earn a percentage of the revenues or a fixed amount depending on the prior agreement.

According to an embodiment herein, a system and a method are provided to broadcast the captured and uploaded videos and audios to a receiver device for projecting/displaying on a screen that looks like an ordinary window to simulate an actual presence on that location in live or time adjusted based on time zone difference at a remote location.

According to an embodiment herein, a system and a method are provided to project the desired geographical view on a residential or commercial place of a user thereby enabling the user to view/see the desired place of living in real time or live or time adjusted mode by opening a blind.

According to an embodiment herein, a system and a method are provided to broadcast the desired geographical view on a mobile or a desk-top computer screen, Television set or a screen that is designed to mimic and/or is built like a window in a residential, hotel or commercial space with the possibility of adding sound, thereby simulating a condition of living or working in the more popular and hard to access locations or visiting the location without paying the higher expenses of living or travel expenses.

According to an embodiment herein, a system and a method are provided to enable the users to place the projectors and cameras alternatively in a popular locations with no actual windows to broadcast videos/pictures with and without sound thereby enabling a reconstruction of a desired scenario/scene at the remote location as one or more small or large windows.

According to an embodiment herein, a system and a method are provided to create a portal/platform/website to provide an online market place for the buyers and sellers/renters to find one or more matches for a fixed rate or auction by paying a percentage or a fixed rate or a membership fee to the portal/platform/website.

According to an embodiment herein, a system and a method are provided to stream the picture/video and sound through the window in a real-time manner with or without sound or be pre-recorded and/or adjusted for the time zone difference between the locations.

According to an embodiment herein, a system and a method are provided to create a website/portal/platform for matching the owners of the sought after “window views” with a potential short or long term renters/leasers or buyers (one or more), through an auction system or a fixed onetime payment or subscription or repetitive periodic payments.

According to an embodiment herein, a system and a method are provided to project the more realistic geographical views on the windows of the buildings using 3D windows, high and higher definition video and sound systems.

According to an embodiment herein, a system and a method are provided for capturing a geographical view and sharing the captured view with a plurality of users through an online marketplace.

According to an embodiment herein, a system and a method are provided for capturing a real-time or live or deferred audio-visual data of a geographical view.

According to an embodiment herein, an online marketplace is provided for sharing and monetizing the captured geographical views.

According to an embodiment herein, a method is provided to monetize the sharing of geographical view through a subscription model or purchase, rent, or lease.

According to an embodiment herein, a method and a system are provided to enable a rendering of a captured view from one remote geographical location to another remote geographical location, where the end-user is present.

According to an embodiment herein, a system and a method are provided to enable the end-user with an option to choose from a plurality of geographical locations to be rendered.

According to an embodiment herein, a system and a method are provided to record or broadcast a live view from a window facing a popular view, say view of the Niagara falls or New York's Times Square, etc., with today's technology of high speed internet, high definition TVs, sound recording and broadcasting systems and cameras and share the captured view with the people in close or remote locations across the globe/world.

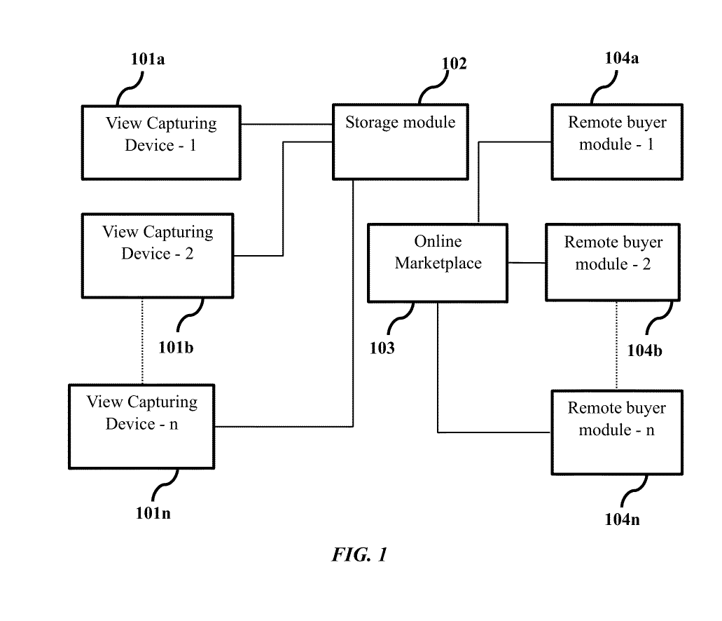

FIG. 1 illustrates a functional block diagram of a system for capturing, monetizing and sharing a geographical view. The system comprises a plurality of View Capturing Devices 101a, 101b, . . . , 101n, Storage module 102, Online Marketplace 103 and a plurality of Remote Buyer modules 104a, 104b, 104n. The View Capturing Devices 101a, 101b, . . . , 101n are configured to capture the audio visual data of a geographical view. The Storage module 102 stores the geographical views captured. The Online Marketplace 103 is created to enable the selling and purchase of geographical views. Remote Buyer modules 104a, 104b, , 104n are enabled to purchase or rent or lease geographical views from the Online Marketplace 103 and render them in display devices.

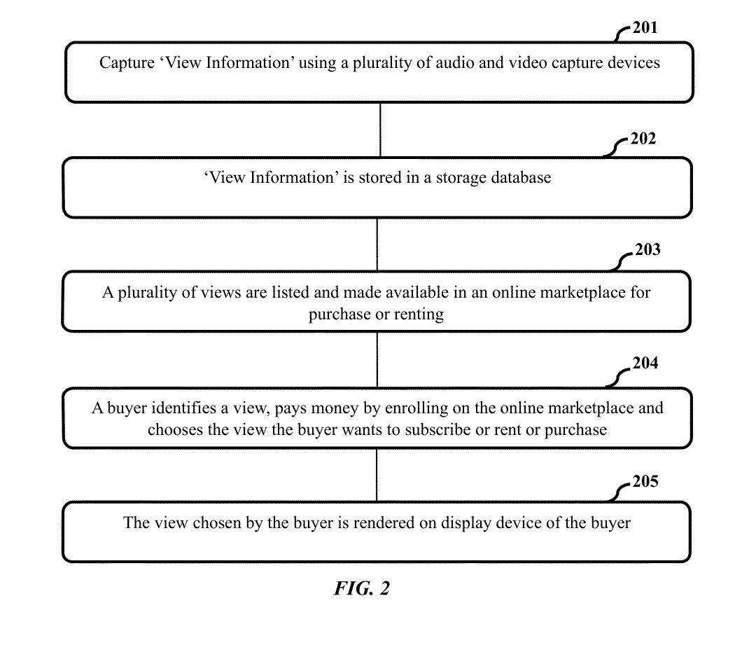

FIG. 2 illustrates a flowchart explaining a process of sharing a plurality of geographical views with a plurality of users and monetizing. The process comprises the following steps: capturing a view information using a plurality of audio and video capture devices (201); storing the captured view information in a storage database (202); listing a plurality of captured views and purchasing or renting or leasing of the plurality of views in an online marketplace (203); enrolling a plurality of users or buyers on the online marketplace, identifying a view, choosing a desired the view, subscribing or renting or purchasing the chosen view (204); and rendering the view chosen and subscribed by the buyer on a plurality of display devices of the user (205).

According an embodiment herein, a computer implemented method comprising instructions stored on a non-transitory computer readable storage medium and run on a computing device provided with a hardware processor and memory for capturing, sharing and projecting a window side view of a desired geographical location on a window of a user building is provided. The method comprises the steps of capturing a window side view of a plurality of geographical locations with a plurality of view capturing devices. The plurality of view capturing devices is located at a plurality of geographical locations. The plurality of view capturing devices includes a plurality of image capturing devices and/or a plurality of audio capturing devices. The plurality of image capturing devices is configured to capture and record a video, or a still picture image of a desired scene/window side view of a desired geographical location. The plurality of audio capturing devices is configured to capture and record an audio of a desired scene/window side view of a desired geographical location. The plurality of view capturing devices is mounted on a viewing window. The image capturing device is a camera or a video camera.

The captured video/image and/or audio of the plurality of geographical locations are stored in a storage database. The storage database is a cloud database.

The captured video/image and/or audio of the plurality of geographical locations are listed on a portal/platform through a server. The server is provided on a portal//platform. The server is connected to the plurality of view capturing devices and the digital storage medium to receive and store the captured images and/or audios of the plurality of geographical locations. The server is configured to share the captured images and/or audios of the plurality of geographical locations with a plurality of users after enrolling the plurality of users. The plurality of users includes a plurality of buyers, sellers, lessees. The portal is configured to enable the plurality of users to purchase or rent or lease the plurality of captured video/image and/or audio in an online marketplace.

A view of a desired geographical location is identifying from the list of the captured video/image and/or audio of the plurality of geographical locations on a portal/platform through the user computing device and the server.

A payment is made to receive the identified view of the desired geographical location through the portal. The payment is made to buy or subscribe or to receive on lease the receive the identified view of the desired geographical location;

The identified view of the desired geographical location is transmitted or transferred to the user device from the portal after confirming the receipt of payment from the user.

The identified view of the desired geographical location is rendered on a display screen provided on the window to mimic or simulate or to project a window side view of the desired geographical location in real time or in live mode or in a time adjusted mode based on the a time difference between the time zones of captured and displayed geographical locations.

According an embodiment herein, the captured images are projected in a two dimension format or three dimensional format. The captured audios are output in mono mode or stereo mode. The captured video is transmitted as a video stream. The captured audio is transmitted as an audio stream.

According an embodiment herein, the captured views are shared in real-time or live or in deferred mode based on a plurality of preferences. The plurality of preferences includes a time of day, season or type of geographical phenomenon. The preferences are set by the user who buys or rents or leases the captured images and audios.

According an embodiment herein, the method 4, further comprises simulating a live atmosphere or environment of a desired geographical location based on the captured images and/or audios of the desired application on a window of the building using a simulation engine.

According an embodiment herein, the building is any one of a residential building, a commercial building and an office building. The window of the building is a Three Dimensional Window screen.

According an embodiment herein, the method further comprises displaying the captured audio and/or video of the desired geographical location through projectors or televisions. The television is a normal or a high-definition television receiver set.

According an embodiment herein, the method further comprises transmitting the captured video and/or audio of the plurality of geographical locations through a broadcast system.

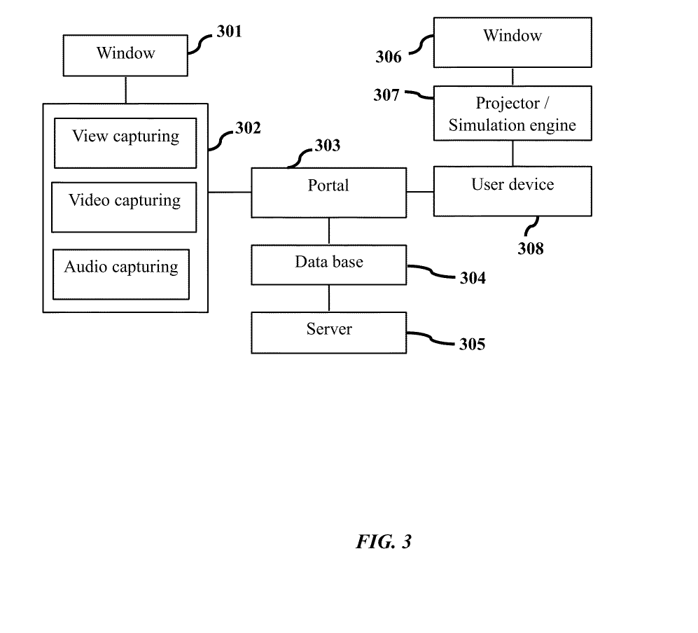

FIG. 3 illustrates a circuit block diagram of a system for capturing, monetizing and sharing a geographical view, according to an embodiment herein. With respect to FIG. 3, a system is provided for capturing, storing, sharing and monetizing a window view/scene from a geographical location. The system comprises a plurality of view capturing devices 302 located at a plurality of geographical locations. The plurality of view capturing devices 302 includes a plurality of image capturing devices and/or a plurality of audio capturing devices. The plurality of image capturing devices is configured to capture and record a video, or a still picture image of a desired scene/window side view of a desired geographical location. The plurality of audio capturing devices is configured to capture and record an audio of a desired scene/window side view of a desired geographical location.

A digital storage mechanism or a data base 304 is configured to store the captured video, images and audio in a digital format. The storage mechanism is located locally or remotely to the view capturing devices. The captured video, images and audio are transferred from the view capturing devices to the storage mechanism through a wired/wireless network.

A server 305 is provided on a portal 303/platform. The server 305 is connected to the plurality of view capturing devices 302 and the digital storage medium to receive and store the captured images and audios of the plurality of geographical locations. The server 305 is configured to share the captured images and audios of the plurality of geographical locations with a plurality of users. The plurality of users includes a plurality of buyers, sellers, lessees.

According an embodiment herein, the plurality of buyers are enabled to acquire the captured images and audios of the plurality of geographical locations for projecting the captured images and audios on a window in a building of the buyers to simulate a live or recorded view of a desired geographical location. The captured images and audios are broadcast in a real time or live or in a time adjusted mode based on a time difference and time zone difference between the geographical location and a projected location.

According an embodiment herein, the captured images are projected in a two dimension format or three dimensional format.

According an embodiment herein, the captured audios are output in mono mode or stereo mode.

According an embodiment herein, the captured views are shared in real-time or live or in deferred mode based on a plurality of preferences. The plurality of preferences includes a time of day, season or type of geographical phenomenon. The preferences are set by the user who buys or rents or leases the captured images and audios.

According an embodiment herein, the system further comprises a simulation engine/system 307 to simulate a live atmosphere or environment of a desired geographical location based on the captured images and/or audios of the desired application on a window of the building.

According an embodiment herein, the building is any one of a residential building, a commercial building and an office building.

According an embodiment herein, the window 306 of the building is a Three Dimensional Window screen.

According an embodiment herein, the system further comprises projectors 307 or televisions to display the captured audio and/or video of the desired geographical location. The television is a normal or a high-definition television receiver set.

According an embodiment herein, the image capturing device is a camera or a video camera.

According an embodiment herein, the data transmission system is a broadcast system.

According an embodiment herein, the plurality of view capturing devices 302 is mounted on a viewing window 301.

According an embodiment herein, the captured video is transmitted as a video stream and wherein the captured audio is transmitted as an audio stream.

According an embodiment herein, the data base is a cloud database 304.

According an embodiment herein, a method is provided for capturing, sharing and projecting a window side view of a desired geographical location on a window of a user building is provided. The method comprises the steps of capturing a window side view of a plurality of geographical locations with a plurality of view capturing devices. The plurality of view capturing devices is located at a plurality of geographical locations. The plurality of view capturing devices includes a plurality of image capturing devices and/or a plurality of audio capturing devices. The plurality of image capturing devices is configured to capture and record a video, or a still picture image of a desired scene/window side view of a desired geographical location. The plurality of audio capturing devices is configured to capture and record an audio of a desired scene/window side view of a desired geographical location. The plurality of view capturing devices is mounted on a viewing window. The image capturing device is a camera or a video camera.

The captured video/image and/or audio of the plurality of geographical locations are stored in a storage database. The storage database is a cloud database.

The captured video/image and/or audio of the plurality of geographical locations are listed on a portal/platform through a server. The server is provided on a portal//platform. The server is connected to the plurality of view capturing devices and the digital storage medium to receive and store the captured images and/or audios of the plurality of geographical locations. The server is configured to share the captured images and/or audios of the plurality of geographical locations with a plurality of users after enrolling the plurality of users. The plurality of users includes a plurality of buyers, sellers, lessees. The portal is configured to enable the plurality of users to purchase or rent or lease the plurality of captured video/image and/or audio in an online marketplace.

A view of a desired geographical location is identifying from the list of the captured video/image and/or audio of the plurality of geographical locations on a portal/platform through the user computing device and the server.

A payment is made to receive the identified view of the desired geographical location through the portal. The payment is made to buy or subscribe or to receive on lease the receive the identified view of the desired geographical location;

The identified view of the desired geographical location is transmitted or transferred to the user device from the portal after confirming the receipt of payment from the user.

The identified view of the desired geographical location is rendered on a display screen provided on the window to mimic or simulate or to project a window side view of the desired geographical location in real time or in live mode or in a time adjusted mode based on the a time difference between the time zones of captured and displayed geographical locations.

According an embodiment herein, the captured images are projected in a two dimension format or three dimensional format. The captured audios are output in mono mode or stereo mode. The captured video is transmitted as a video stream. The captured audio is transmitted as an audio stream.

According an embodiment herein, the captured views are shared in real-time or live or in deferred mode based on a plurality of preferences. The plurality of preferences includes a time of day, season or type of geographical phenomenon. The preferences are set by the user who buys or rents or leases the captured images and audios.

According an embodiment herein, the method 4, further comprises simulating a live atmosphere or environment of a desired geographical location based on the captured images and/or audios of the desired application on a window of the building using a simulation engine.

According an embodiment herein, the building is any one of a residential building, a commercial building and an office building. The window of the building is a Three Dimensional Window screen.

According an embodiment herein, the method further comprises displaying the captured audio and/or video of the desired geographical location through projectors or televisions. The television is a normal or a high-definition television receiver set.

According an embodiment herein, the method further comprises transmitting the captured video and/or audio of the plurality of geographical locations through a broadcast system.

The advantages of the embodiments disclosed herein comprise the sharing of real-time geographical view of one part of the world with any remote user in any other part of the world. The present embodiments enable a user to experience a geographical view without actually travelling to the geographical, which saves a lot of costs and travel. The present embodiments also enable a user to customize the view from the user's home or workplace to the view of any geographical location in the world.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the appended claims.

It is also to be understood that the following claims are intended to cover all of the generic and specific features of the embodiments described herein and all the statements of the scope of the embodiments which as a matter of language might be said to fall there between.

What is claimed is:

1. A system for capturing, storing, sharing and monetizing a window view/scene from a geographical location, the system comprising:
a plurality of view capturing devices located at a plurality of geographical locations, wherein the plurality of view capturing devices includes a plurality of image capturing devices and/or a plurality of audio capturing devices, and wherein the plurality of image capturing devices is configured to capture and record a video, or a still picture image of a desired scene/window side view of a desired geographical location, and wherein the plurality of audio capturing devices is configured to capture and record an audio of a desired scene/window side view of a desired geographical location;
a digital storage mechanism or a data base configured to store the captured video, images and audio in a digital format, wherein the storage mechanism is located locally or remotely to the view capturing devices, and wherein the captured video, images and audio are transferred from the view capturing devices to the storage mechanism through a wired/wireless network;
a server provided on a portal//platform, and wherein the server is connected to the plurality of view capturing devices and the digital storage medium to receive and store the captured images and audios of the plurality of geographical locations and wherein the server is configured to share the captured images and audios of the plurality of geographical locations with a plurality of users, and wherein the plurality of users includes a plurality of buyers, sellers, lessees; and
wherein the plurality of buyers acquire the captured images and audios of the plurality of geographical locations for projecting the captured images and audios on a window in a building of the buyers to simulate a live or recorded view of a desired geographical location, and wherein the captured images and audios are broadcast in a real time or live or in a time adjusted mode based on a time difference and time zone difference between the geographical location and a projected location.

2. The system according to claim 1, wherein the captured images are projected in a two dimension format or three dimensional format.

3. The system according to claim 1, wherein the captured audios are output in mono mode or stereo mode.

4. The system according to claim 1, wherein the captured views are shared in real-time or live or in deferred mode based on a plurality of preferences, and wherein the plurality of preferences includes a time of day, season or type of geographical phenomenon, wherein the preferences are set by the user who buys or rents or leases the captured images and audios.

5. The system according to claim 1, further comprises a simulation engine/system to simulate a live atmosphere or environment of a desired geographical location based on the captured images and/or audios of the desired application on a window of the building.

6. The system according to claim 1, wherein the building is any one of a residential building, a commercial building and an office building.

7. The system according to claim 1, wherein the window of the building is a Three Dimensional Window screen.

8. The system according to claim 1, further comprises projectors or televisions to display the captured audio and/or video of the desired geographical location, and wherein the television is a normal or a high-definition television receiver set.

9. The system according to claim 1, wherein the image capturing device is a camera or a video camera.

10. The system according to claim 1, wherein the data transmission system is a broadcast system.

11. The system according to claim 1, wherein the plurality of view capturing devices is mounted on a viewing window.

12. The system according to claim 1, wherein the captured video is transmitted as a video stream and wherein the captured audio is transmitted as an audio stream.

13. The system according to claim 1, wherein the data base is a cloud database.

14. A computer implemented method comprising instructions stored on a non-transitory computer readable storage medium and run on a computing device provided with a hardware processor and memory for capturing, sharing and projecting a window side view of a desired geographical location on a window of a user building, the method comprises the steps of:
capturing a window side view of a plurality of geographical locations with a plurality of view capturing devices, and wherein the plurality of view capturing devices is located at a plurality of geographical locations, and wherein the plurality of view capturing devices includes a plurality of image capturing devices and/or a plurality of audio capturing devices, and wherein the plurality of image capturing devices is configured to capture and record a video, or a still picture image of a desired scene/window side view of a desired geographical location, and wherein the plurality of audio capturing devices is configured to capture and record an audio of a desired scene/window side view of a desired geographical location, and wherein the plurality of view capturing devices is mounted on a viewing window, and wherein the image capturing device is a camera or a video camera;
storing the captured video/image and/or audio of the plurality of geographical locations in a storage database, and wherein the storage database is a cloud database;
listing the captured video/image and/or audio of the plurality of geographical locations on a portal/platform through a server, and wherein the server is provided on a portal//platform, and wherein the server is connected to the plurality of view capturing devices and the digital storage medium to receive and store the captured images and/or audios of the plurality of geographical locations, and wherein the server is configured to share the captured images and/or audios of the plurality of geographical locations with a plurality of users after enrolling the plurality of users, and wherein the plurality of users includes a plurality of buyers, sellers, lessees, and wherein the portal is configured to enable the plurality of users to purchase or rent or lease the plurality of captured video/image and/or audio in an online marketplace;
identifying a view of a desired geographical location from the list of the captured video/image and/or audio of the plurality of geographical locations on a portal/platform through the user computing device and the server;
making a payment to receive the identified view of the desired geographical location through the portal, and wherein the payment is made to buy or subscribe or to receive on lease the receive the identified view of the desired geographical location;
transmitting or transferring the identified view of the desired geographical location to the user device from the portal after confirming the receipt of payment from the user;
rendering the identified view of the desired geographical location on a display screen provided on the window to mimic or simulate or to project a window side view of the desired geographical location in real time or in live mode or in a time adjusted mode based on the a time difference between the time zones of captured and displayed geographical locations.

15. The method according to claim 14, wherein the captured images are projected in a two dimension format or three dimensional format, and wherein the captured audios are output in mono mode or stereo mode, and wherein the captured video is transmitted as a video stream and wherein the captured audio is transmitted as an audio stream.

16. The method according to claim 14, wherein the captured views are shared in real-time or live or in deferred mode based on a plurality of preferences, and wherein the plurality of preferences includes a time of day, season or type of geographical phenomenon, wherein the preferences are set by the user who buys or rents or leases the captured images and audios.

17. The method according to claim 14, further comprises simulating a live atmosphere or environment of a desired geographical location based on the captured images and/or audios of the desired application on a window of the building using a simulation engine.

18. The method according to claim 14, wherein the building is any one of a residential building, a commercial building and an office building, and wherein the window of the building is a Three Dimensional Window screen.

19. The method according to claim 14, further comprises displaying the captured audio and/or video of the desired geographical location through projectors or televisions, and wherein the television is a normal or a high-definition television receiver set.

20. The method according to claim 14, further comprises transmitting the captured video and/or audio of the plurality of geographical locations through a broadcast system.
